(19) United States
(12) Patent Application Publication
(10) Pub. No.: US 2010/0262681 A1
(43) Pub. Date: Oct. 14, 2010

(54) REMOTE WAKE-UP METHOD, HOST TO BE REMOTELY AWAKED, AND WAKE-UP MANAGEMENT SERVER

(75) Inventors: Chiao-Yung Chang, Taipei (TW); Cheng-Ming Chen, Taipei (TW)

Correspondence Address: KIRTON AND MCCONKIE, 60 EAST SOUTH TEMPLE,, SUITE 1800, SALT LAKE CITY, UT, 84111, US

(73) Assignee: AVERMEDIA TECHNOLOGIES, INC., Taipei (TW)

(21) Appl. No.: 12/542,962

(22) Filed: Aug. 18, 2009

(30) Foreign Application Priority Data
Apr. 13, 2009 (TW) 098112194

(51) Int. Cl. G06F 15/173; G06F 15/177; G06F 21/00

(52) U.S. Cl. 709/221; 709/223; 726/3

(57) ABSTRACT

A remote wake-up method is used between a first host, a second host, a server and the internet. The remote wake-up method includes the following steps. Firstly, the first host communicates with the server through the internet and an identity register procedure is performed. Then, the second host communicates with the server through the internet, an identity authentication procedure is implemented, and the server is triggered to issue a wake-up packet to the first host when the first host is in a wake-up waiting status. Afterwards, the first host enters a normal working status in response to the wake-up packet.

### FIELD OF THE INVENTION

The present invention relates to a remote wake-up method, a host to be remotely awaked and a wake-up management server, and more particularly to a remote wake-up method, a host to be remotely awaked and a wake-up management server for use with an internet.

### BACKGROUND OF THE INVENTION

With rapid expansion of network bandwidth and universality of internet infrastructure, the use of internet to transmit audio/video streaming signal or even TV programs is now gaining in popularity. For example, Slingbox™ is a kind of a set-top box with TV streaming function that enables users to remotely watch their TV programs from internet-enabled computers. FIG. 1 is a schematic functional block diagram of a conventional audio/video streaming signal sharing system. The conventional audio/video streaming signal sharing system has a TV streaming device 91 such as Slingbox™, which is interconnected between a TV signal source 90 and an internet 9. By the TV streaming device 91, the TV signals from the TV signal source 90 are converted into network audio/video streaming signals. The network audio/video streaming signals can be transmitted to any computer that communicates with the internet 9. For example, after the TV streaming device 91 communicates with internet 9, the TV streaming device 91 can redirect the TV signals to a notebook computer 92 or a desktop computer 93, which is running SlingPlayer software. In other words, the TV signals can be transmitted from the TV streaming device 91 to the users computers located anywhere in the world through internet connection. Furthermore, the users can remotely control the TV signal source 90 connected to the TV streaming device 91 by the internet-enabled computer. An example of the TV signal source 90 includes but is not limited to a cable box, a satellite receiver or a digital video recorder.

The conventional audio/video streaming signal sharing system, however, still has some drawbacks. For example, for a purpose of connecting the TV streaming device 91 to internet 9, the far-end user should firstly realize the IP address of the TV streaming device 91 or set up a user account. The user having an authenticated password can access the TV steaming device 91 to receive the network audio/video streaming signals as described above. In addition, only one computer can access the TV steaming device 91 at a time. Under this circumstance, the conventional audio/video streaming signal sharing system is not an effective way for sharing resources.

For solving the above drawbacks, a pending U.S. patent application Ser. No. 12/193,231 is disclosed, which is entitled “Audio/video streaming signal provision method and sharing system” and the contents of which are hereby incorporated by reference.

According to the disclosure of U.S. patent application Ser. No. 12/193,231, a service management server is connected to the internet. Through the internet connection, the user hardware device can download user software or sharer software from the service management server so as to install the user software or the sharer software in personal computers. The personal computer containing the installed user software (also referred as user computer) and the personal computer containing the installed sharer software (also referred as sharer computer) could communicate with the service management server and perform a register process through the internet connection. By means of the register process, the service management server could acquire the identification data of the user computer and the sharer computer. Moreover, the sharer computer is a personal computer having a built-in TV tuner card or a TV tuner box for receiving a TV signal and converting the TV signal into an audio/video streaming signal. The audio/video streaming signals could be transmitted to any remote user computer that communicates with the internet.

In a case that the personal computer having a built-in TV tuner card or TV tuner box is powered off, the remote user computer fails to view TV programs by the audio/video streaming signal sharing system described in U.S. patent application Ser. No. 12/193,231. Nowadays, remote wake-up technologies are developed for allowing the remote user computer to view the TV programs that are shared by the sharer computer. The common remote wake-up technologies are generally classified into two types. The first type of remote wake-up technology is a Wake on Ring (WOR) technology or a Wake on Modem (WOM) technology. Via a telephone wire, the user computer could issue a specific signal to the modulator-demodulator (modem) of the computer to be awaked. Since the modulator-demodulator is gradually replaced, a telephone wire and a wire linkage are required and no user authentication mechanism is employed, the first type of remote wake-up technology is inconvenient and unsafe. The second type of remote wake-up technology is Wake on LAN (WOL) technology. When a computer to be awaked is in a hibernation status or a power-off status, the user will transmit a network wake-up packet (also referred as a magic pocket) to a network interface card of the computer to be awaked through a local area network (LAN). When the network wake-up packet is received by the network interface card, the network interface card will determine whether the format of the network wake-up packet is accurate and the contents of the network wake-up packet involve the wake-up event. Once the format of the network wake-up packet is accurate and the contents of the network wake-up packet involve the wake-up event, the computer will be awaked. As known, the WOL technology needs to change the settings of the motherboard, the network interface card and the operating system of the computer in the wake-up waiting mode. The use of the interface is inconvenient. In addition, the WOL technology could only be used in the LAN environment. For most users, the audio/video streaming signal sharing system described in U.S. patent application Ser. No. 12/193,231 will not be operated in the LAN environment, and thus the WOL technology fails to effectively awake the computer in such audio/video streaming signal sharing system.

Therefore, there is a need of providing a remote wake-up method to obviate the drawbacks encountered from the prior art.

### SUMMARY OF THE INVENTION

In accordance with an aspect of the present invention, there is provided a remote wake-up method for use between a first host, a second host, a server and an internet. The remote wake-up method includes the following steps. Firstly, the first host communicates with the server through the internet and an identity register procedure is performed. Then, the second host communicates with the server through the internet, an identity authentication procedure is implemented, and the server is triggered to issue a wake-up packet to the first host when the first host is in a wake-up waiting status. Afterwards, the first host enters a normal working status in response to the wake-up packet.

In an embodiment, the first host is a sharer computer having an installed application program and a built-in image source device, the sharer computer is connected to the internet through a router, and the application program implements an identity register procedure in the sharer computer. The identity register procedure includes steps of: directing the sharer computer to a specified port number of the router according to a universal plug and play technology; performing a setting operation on a dynamic domain name service of the router; and transmitting a user identification data of the sharer computer to the server and storing the user identification data in the server, thereby implementing the identity register procedure.

In an embodiment, the identity authentication procedure includes steps of: allowing the second host to communicate with the server by executing a browser program in the second host to access the internet; inputting the user identification data through the browser program and transmitting the user identification data to the server; and finishing the identity authentication procedure if the server confirms that the user identification data transmitted from the second host complies with the user identification data stored in the server.

In an embodiment, the wake-up waiting status includes a standby status, a hibernation status or a power-off status.

In accordance with another aspect of the present invention, there is provided a host to be remotely awaked. The host communicates with a second host, a server and an internet. The host includes a host main body, an application program and an image source device. The host main body is connected to the server through the internet. The second host communicates with the server through the internet, implements an identity authentication procedure and triggers the server to issue a wake-up packet to the host main body. The host main body is switched from a wake-up waiting status to a normal working status in response to the wake-up packet. The application program is executed in the host main body to implement an identity register procedure in the server. The image source device is electrically connected to the host main body for generating and transmitting an image signal to the second host through the internet under control of the application program.

In an embodiment, the host main body is a personal computer communicating with the internet through a router, and the image source device is a TV tuner card or a TV tuner box.

In an embodiment, the identity register procedure implemented in the personal computer by the application program includes steps of: directing the personal computer to a specified port number of the router according to a universal plug and play technology; performing a setting operation on a dynamic domain name service of the router; and transmitting a user identification data of the personal computer to the server and storing the user identification data in the server, thereby implementing the identity register procedure.

In an embodiment, the identity authentication procedure implemented by the second host includes steps of: allowing the second host to communicate with the server by executing a browser program in the second host to access the internet; inputting the user identification data through the browser program and transmitting the user identification data to the server; and finishing the identity authentication procedure if the server confirms that the user identification data transmitted from the second host complies with the user identification data stored in the server.

In an embodiment, the wake-up waiting status includes a standby status, a hibernation status or a power-off status.

In an embodiment, the information associated with a schedule time of the image source device is automatically transmitted to the server by the application program and stored in the server. The server awakes the host main body before the schedule time so as to execute a scheduled recording task corresponding to the schedule time.

In accordance with a further aspect of the present invention, there is provided a wake-up management server for use between a first host, a second host and an internet. The wake-up management server includes a database module, a dynamic domain name service module and a wake-up packet generating module. The database module is used for recording a user identification data of the first host. The dynamic domain name service module is used for recording an IP address corresponding to the first host, wherein the dynamic domain name service module performs a data refreshing operation if the IP address corresponding to the first host is changed. The wake-up packet generating module is for determining whether the user identification data transmitted from the second host through the internet complies with the user identification data recorded in the database module to implement an identity authentication procedure. If the user identification data transmitted from the second host complies with the user identification data recorded in the database module, the wake-up packet generating module issues a wake-up packet to the first host. The first host is switched from a wake-up waiting status to a normal working status in response to the wake-up packet.

In an embodiment, the first host is a sharer computer having an installed application program and a built-in image source device. The sharer computer is connected to the internet through a router. The IP address corresponding to the first host is a combination of an external IP address of the router and a specified port number of the router.

In an embodiment, the wake-up waiting status includes a standby status, a hibernation status or a power-off status.

In an embodiment, the user identification data includes a user name and a user password.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic functional block diagram of a conventional audio/video streaming signal sharing system;

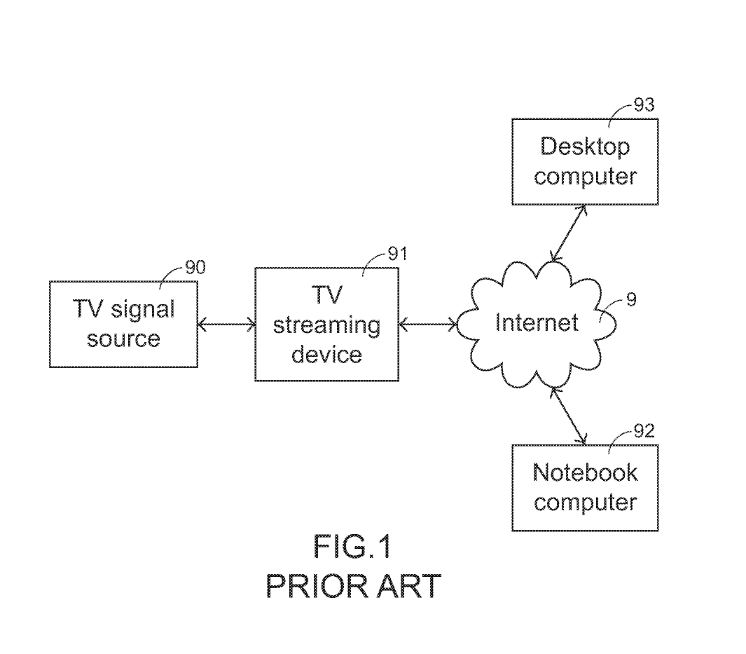

FIG. 2 is a schematic functional block diagram illustrating a remote wake-up system according to an embodiment of the present invention;

FIG. 3A is a flowchart illustrating a process for registering user identification data in the wake-up management server;

FIG. 3B is a flowchart illustrating a strategic decision procedure for switching from a wake-up waiting status to a wake-up status in the sharer computer;

FIG. 3C is a flowchart illustrating a strategic decision procedure for remotely activating the sharer computer by a user computer; and

FIG. 4 is a flowchart illustrating a strategic decision procedure used in the wake-up management server of the remote wake-up system.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

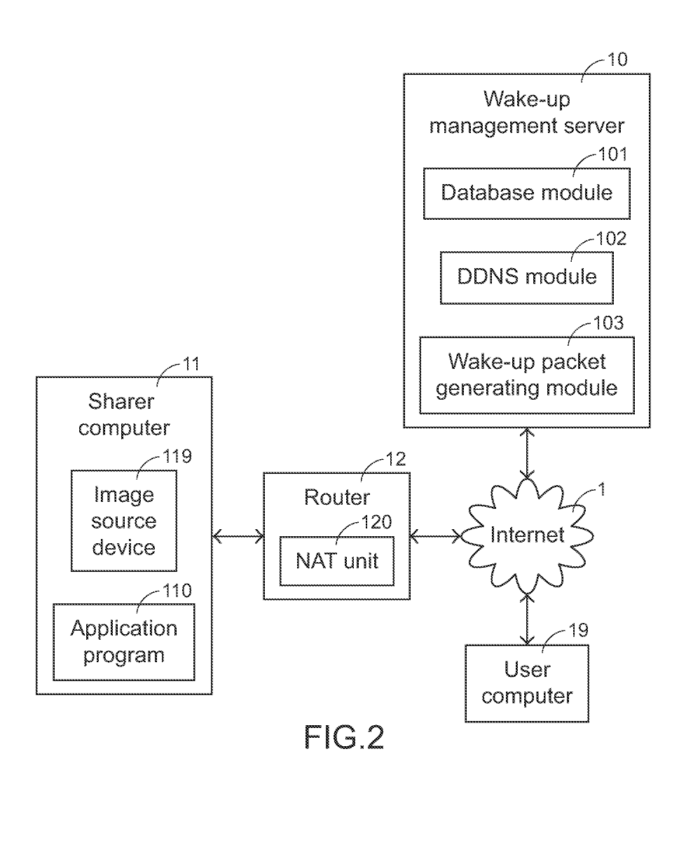

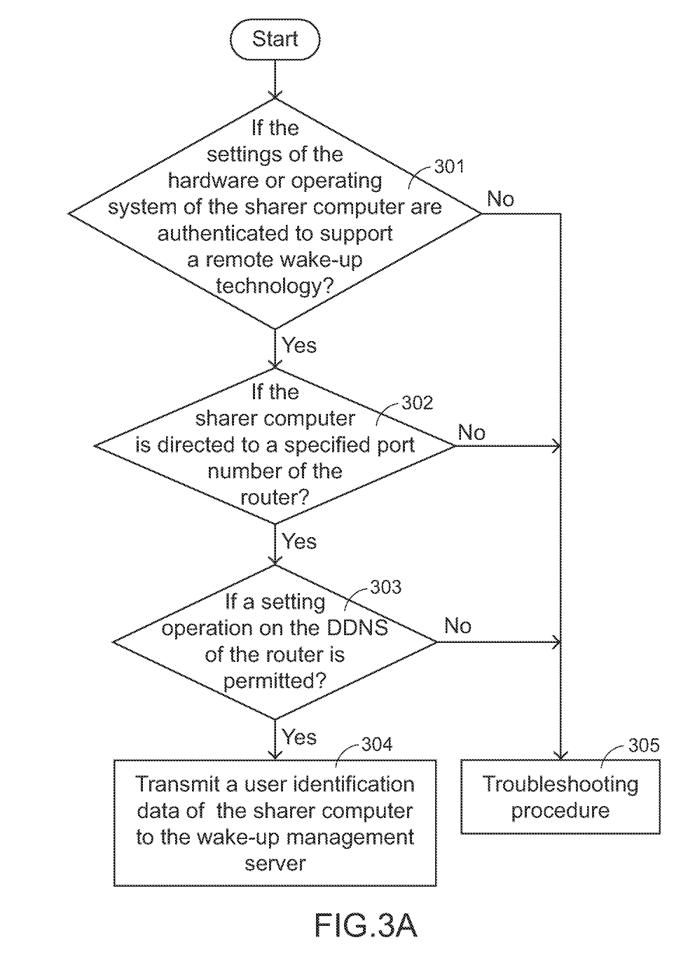

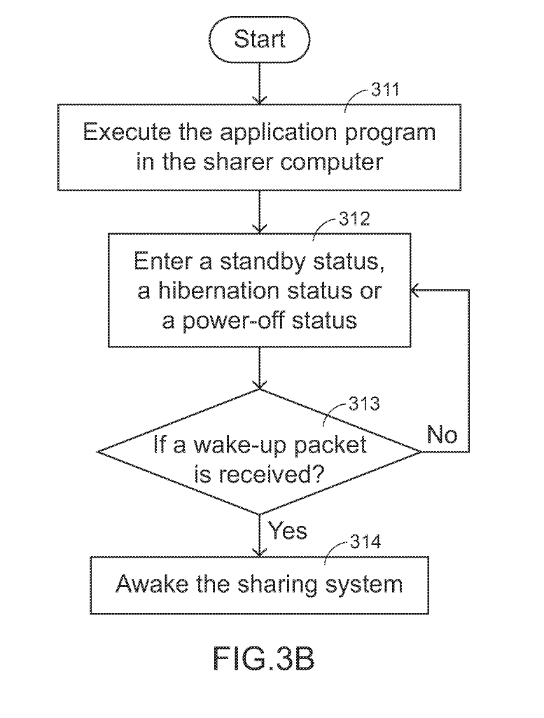

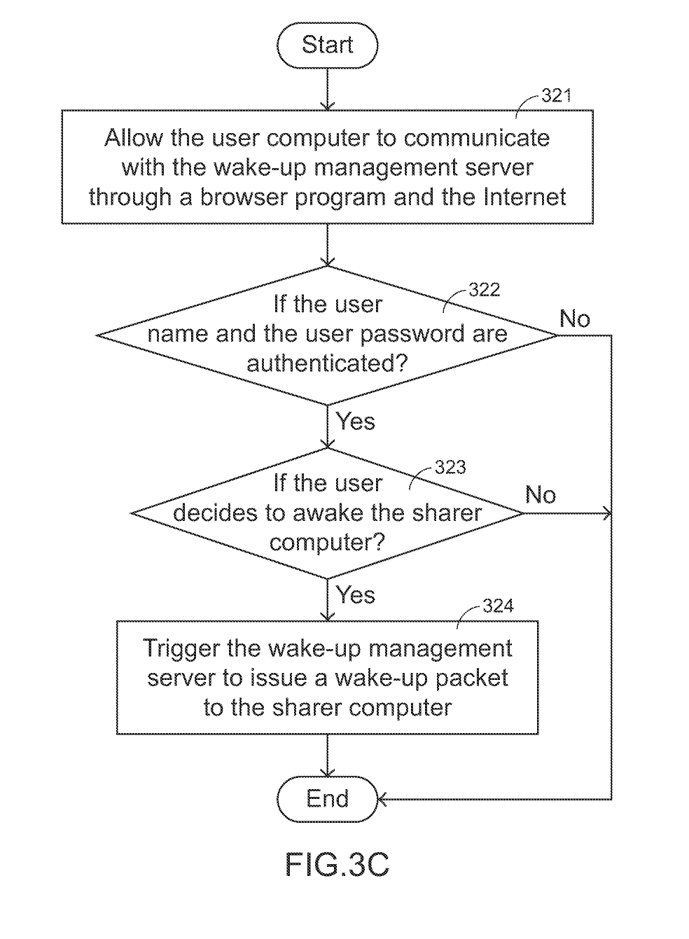

FIG. 2 is a schematic functional block diagram illustrating a remote wake-up system according to an embodiment of the present invention. As shown in FIG. 2, the remote wake-up system comprises an internet 1, a sharer computer 11, a router 12, a wake-up management server 10 and a user computer 19. The sharer computer 11 communicates with the internet 1 through the router 12. The sharer computer 11 has a built-in image source device 119 such as a TV tuner card or a TV tuner box. An application program 110 is installed in the sharer computer 11. After the application program 110 is executed, a process for registering user identification data in the wake-up management server 10 will be illustrated with reference to the flowchart of FIG. 3A. First of all, if the settings of the hardware or operating system of the sharer computer 11 are authenticated to have the capability to support a remote wake-up technology (Step 301), the application program 110 will determine whether the sharer computer 11 is directed to a specified port number of the router 12 according to a universal plug and play (UPnP) technology or another technology in order to pass through a network address translation (NAT) unit 120 of the router 12 (Step 302). Once the sharer computer 11 is directed to a specified port number of the router 12, the computer (e.g. the user computer 19) that is connected to the internet 1 could communicate with the sharer computer 11 through the specified port number of the router 12, thereby displaying the image signals generated by the image source device 119 of the sharer computer 11. Next, if a setting operation on the dynamic domain name service (DDNS) of the router 12 is permitted (Step 303), a user identification data of the sharer computer 11 is transmitted to the wake-up management server 10 (Step 304). In a case that one of the conditions described in Steps 301, 302 and 303 is not satisfied, a troubleshooting procedure is performed (Step 305).

For facilitating the user computer 19 to quickly communicate with the sharer computer 11, the wake-up management server 10 is connected to the internet 1 and has a public IP address. The wake-up management server 10 includes one or more distributed server hosts. The sharer computer 11 executing the application program 110 could register user identification data in the wake-up management server 10 via the internet 1. As shown in FIG. 2, the wake-up management server 10 comprises a database module 101, a dynamic domain name service (DDNS) module 102 and a wake-up packet generating module 103. The database module 101 is used for recording multiple user identification data of multiple sharer computers. Each of the user identification data includes a user name, a user password and the requisite conditions of the sharer computer. The requisite conditions of the sharer computer include a domain name of the sharer computer, the specified port number designated by the router 12, and the like. The DDNS module 102 is used for recording the IP addresses corresponding to the domain names of the sharer computers. For example, as shown in FIG. 2, the IP address of the router 12 corresponding to the sharer computer 11 could be recorded in the DDNS module 102. If the IP address of the router 12 is changed, the DDNS module 102 performs a data refreshing operation. On the other hand, if the sharer computer 11 is directly connected to the internet and only has an IP address, the specified port number is not necessarily recorded in the DDNS module 102. The wake-up packet generating module 103 is used for authenticating the user's identity and sending out a wake-up packet.

After the sharer computer 11 executing the application program 110 registers the user identification data in the wake-up management server 10 by using the identity register procedure as described in FIG. 3A, the wake-up management server 10 has stored the user identification data of the sharer computer 11. Moreover, a strategic decision procedure executable in the sharer computer 11 will be illustrated with reference to FIG. 3B. FIG. 3B is a flowchart illustrating a strategic decision procedure for switching from a wake-up waiting status to a wake-up status in the sharer computer 11. After the application program 110 is executed in the sharer computer 11 (Step 311), the sharer computer 11 enters a wake-up waiting status such as a standby status, a hibernation status or a power-off status (Step 312). At the same time, the application program 110 executed in the sharer computer 11 will notify the wake-up management server 10 that the sharer computer 11 is in the wake-up waiting status through the internet 1. As such, the wake-up management server 10 realizes that the sharer computer 11 could be remotely awaked and the wake-up management server 10 will have the newest conditions of the sharer computer 11. If a wake-up packet issued from the wake-up management server 10 is received by the sharer computer 11 (Step 313), the sharing system is awaked (Step 314).

For remotely awaking the sharer computer 11, the user could utilize any computer that is connected to the internet 1 (e.g. the user computer 19). FIG. 3C is a flowchart illustrating a strategic decision procedure for remotely activating the sharer computer 11 by a user computer 19. Firstly, the user computer 11 communicates with the wake-up management server 10 through a browser program and the internet (Step 321). If the user identification data (e.g. the user name and the user password) are authenticated (Step 322), a user interface for awaking one or more sharer computers 11 corresponding to the user identification data will be created. Via the user interface, the remote user could input instructions to awake the sharer computers 11. If the user decides to awake the sharer computers 11 (Step 323), the user computer 19 could select the domain name of the sharer computer 11. According to the domain name, the wake-up management server 10 will acquire the IP address corresponding to the domain name of the sharer computer 11 from the DDNS module 102. In addition, the wake-up management server 10 will acquire the specified port number of the router 12. According to a combination of the IP address and the specified port number of the router 12, the wake-up packet generating module 103 of the wake-up management server 10 is triggered to issue the wake-up packet to the sharer computer 11 (Step 324). Even if the user computer 19 and sharer computer 11 are connected to different local area networks, the sharer computer 11 could be successfully awaked by the remote wake-up method of the present invention.

In some embodiments, the functions of the wake-up management server 10 are integrated into the service management server of the audio/video streaming signal sharing system described in U.S. patent application Ser. No. 12/193,231. Alternatively, the wake-up management server 10 is separate from the service management server.

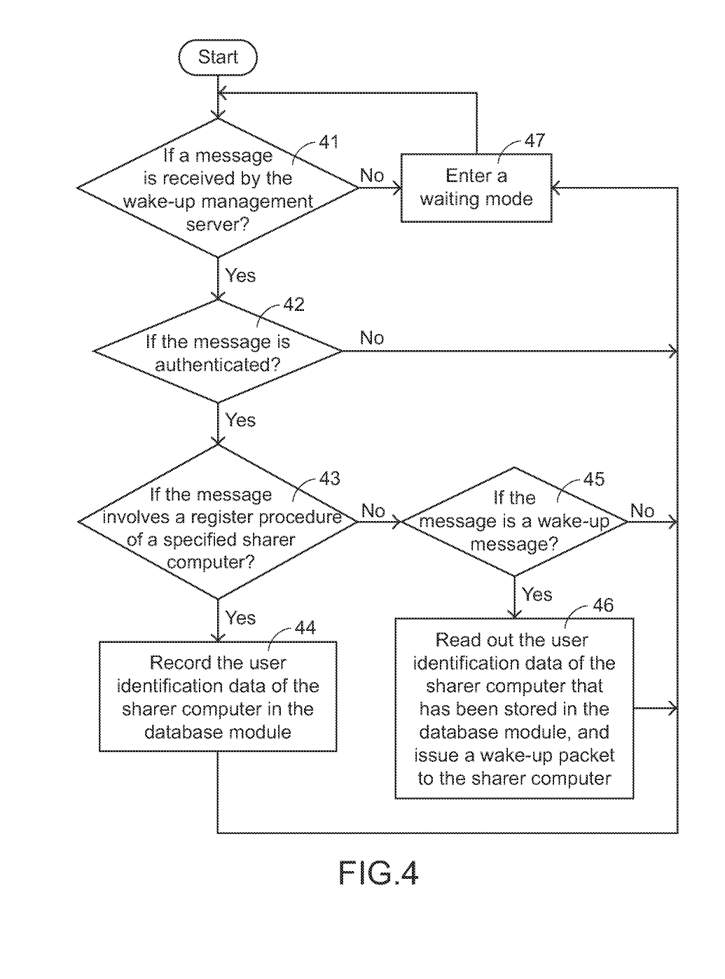

FIG. 4 is a flowchart illustrating a strategic decision procedure used in the wake-up management server 10 of the remote wake-up system. Firstly, if a message is received by the wake-up management server 10 (Step 41), the wake-up management server 10 will determine whether the message is authenticated (Step 42). Once the message is authenticated, the wake-up management server 10 will determine whether the message involves the identity register procedure of a specified sharer computer 11 (Step 43). Once the message involves the identity register procedure of the specified sharer computer 11, the user identification data of the sharer computer is recorded in the database module 101 of the wake-up management server 10 (Step 44). If the message does not involve the identity register procedure of the specified sharer computer 11, the wake-up management server 10 will determine whether the message is a wake-up message (Step 45). Once the message is a wake-up message, the user identification data of the sharer computer 11 that has been stored in the database module 101 of the wake-up management server 10 is read out and the wake-up management server 10 issues a wake-up packet to the sharer computer 11 (Step 46). In a case that one of the conditions described in Steps 41, 42 and 45 is not satisfied, the wake-up management server 10 enters a waiting mode to wait for a next message (Step 47).

In practice, the personal computer used in the home environment could be set as a sharer computer that is permitted to be remotely awaked. When the user is not at home, the user could awake the sharer computer via any other user computer. By inputting the user identification data (e.g. the user name and the user password) into the user computer, the sharer computer is awaked through the wake-up management server. After the sharer computer is awaked, the functions of the TV tuner card or the TV tuner box are activated, and thus the user could view TV programs shared by the sharer computer. In some embodiments, the user could set a recording schedule related to the sharer computer and the application program could automatically transmit the scheduled time information to the wake-up management server for storage. The wake-up management server will awake the sharer computer before the schedule time, so that the sharer computer will execute a scheduled recording task corresponding to the schedule time.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A remote wake-up method for use between a first host, a second host, a server and an internet, the remote wake-up method comprising steps of:
allowing the first host to communicate with the server through the internet, and implementing an identity register procedure;
allowing the second host to communicate with the server through the internet, implementing an identity authentication procedure, and triggering the server to issue a wake-up packet to the first host when the first host is in a wake-up waiting status; and
allowing the first host to enter a normal working status in response to the wake-up packet.

2. The remote wake-up method according to claim 1 wherein the first host is a sharer computer having an installed application program and a built-in image source device, the sharer computer is connected to the internet through a router, and the application program implements an identity register procedure, the identity register procedure comprising steps of:
directing the sharer computer to a specified port number of the router according to a universal plug and play technology;
performing a setting operation on a dynamic domain name service of the router; and
transmitting a user identification data of the sharer computer to the server and storing the user identification data in the server, thereby implementing the identity register procedure.

3. The remote wake-up method according to claim 2 wherein the identity authentication procedure comprises steps of:
allowing the second host to communicate with the server by executing a browser program in the second host to access the internet;
inputting the user identification data through the browser program and transmitting the user identification data to the server; and
finishing the identity authentication procedure if the server confirms that the user identification data transmitted from the second host complies with the user identification data stored in the server.

4. The remote wake-up method according to claim 1 wherein the wake-up waiting status includes a standby status, a hibernation status or a power-off status.

5. A host to be remotely awaked, the host communicating with a second host, a server and an internet, the host comprising:
a host main body connected to the server through the internet, wherein the second host communicates with the server through the internet, implements an identity authentication procedure and triggers the server to issue a wake-up packet to the host main body, and the host main body is switched from a wake-up waiting status to a normal working status in response to the wake-up packet;
an application program executed in the host main body to implement an identity register procedure in the server; and
an image source device electrically connected to the host main body for generating and transmitting an image signal to the second host through the internet under control of the application program.

6. The host according to claim 5 wherein the host main body is a personal computer communicating with the internet through a router, and the image source device is a TV tuner card or a TV tuner box.

7. The host according to claim 6 wherein the identity register procedure implemented in the personal computer by the application program comprises steps of:
directing the personal computer to a specified port number of the router according to a universal plug and play technology;
performing a setting operation on a dynamic domain name service of the router; and
transmitting a user identification data of the personal computer to the server and storing the user identification data in the server, thereby implementing the identity register procedure.

8. The host according to claim 7 wherein the identity authentication procedure implemented by the second host comprises steps of:
allowing the second host to communicate with the server by executing a browser program in the second host to access the internet;
inputting the user identification data through the browser program and transmitting the user identification data to the server; and
finishing the identity authentication procedure if the server confirms that the user identification data transmitted from the second host complies with the user identification data stored in the server.

9. The host according to claim 5 wherein the wake-up waiting status includes a standby status, a hibernation status or a power-off status.

10. The host computer according to claim 5 wherein the information associated with a schedule time of the image source device is automatically transmitted to the server by the application program and stored in the server, and the server awakes the host main body before the schedule time so as to execute a scheduled recording task corresponding to the schedule time.

11. A wake-up management server for use between a first host, a second host and an internet, the wake-up management server comprising:
a database module for recording a user identification data of the first host;
a dynamic domain name service module for recording an IP address corresponding to the first host, wherein the dynamic domain name service module performs a data refreshing operation if the IP address corresponding to the first host is changed; and
a wake-up packet generating module for determining whether the user identification data transmitted from the second host through the internet complies with the user identification data recorded in the database module to implement an identity authentication procedure, wherein if the user identification data transmitted from the second host complies with the user identification data recorded in the database module, the wake-up packet generating module issues a wake-up packet to the first host, and the first host is switched from a wake-up waiting status to a normal working status in response to the wake-up packet.

12. The wake-up management server according to claim 11 wherein the first host is a sharer computer having an installed application program and a built-in image source device, the sharer computer is connected to the internet through a router, the IP address corresponding to the first host is a combination of an external IP address of the router and a specified port number of the router.

13. The wake-up management server according to claim 11 wherein the wake-up waiting status includes a standby status, a hibernation status or a power-off status.

14. The wake-up management server according to claim 11 wherein the user identification data includes a user name and a user password.
